(19) United States
(12) Patent Application Publication
(10) Pub. No.: US 2017/0154109 A1
(43) Pub. Date: Jun. 1, 2017

(54) SYSTEM AND METHOD FOR LOCATING AND NOTIFYING A USER OF THE MUSIC OR OTHER AUDIO METADATA

(71) Applicant: SPOTIFY AB, Stockholm (SE)

(72) Inventors: Dave Lynch, Dublin (IE); Brendan O'Driscoll, Dublin (IE); Craig Watson, Dublin (IE); Aidan Sliney, Dublin (IE)

(21) Appl. No.: 15/301,700

(22) PCT Filed: Apr. 2, 2015
(86) PCT No.: PCT/EP2015/057341

§ 371 Date: Oct. 3, 2016

Related U.S. Application Data
(60) Provisional application No. 61/974,451, filed on Apr. 3, 2014.

(51) Int. Cl. G06F 17/30; H04W 4/02

(52) U.S. Cl. CPC G06F 17/30752; G06F 17/30241; H04W 4/023

(57) ABSTRACT

The invention provides a system and method for locating and notifying a user of the music or other audio metadata matching the user's stated preference by appending location information to such metadata.

### FIELD

The present invention relates generally to a system and method for locating and notifying a user of music or audio metadata.

### BACKGROUND

As the proliferation of electronic devices continues, it should be noted that such electronic devices are now increasingly capable of capturing their location at any point in time using a number of existing technologies including, but not limited to GPS, wireless triangulation and system networks or a combination of same. In tandem, there is now also an increase in the contextualization of location with the emergence of a new generation of location based services. These services are used to assist users with everything ranging from navigation to finding areas of interest nearby to searching for properties to rent in new locations. At a more hyper-local level, there is also an emerging trend of seeing what is relevant to you in your immediate vicinity with technologies such as Google Glass using bespoke hardware and location based software to facilitate this demand.

The original location based services aimed to provide visual points of reference which anchored certain nodes to a static map (e.g. Yelp which sets out the location and corresponding review for restaurants in a number of cities). Location based services then evolved into more fluid and dynamic interfaces so that users could see real-time updates for such points of reference (e.g. Foursquare which allows users to ‘check-in’ to such locations—‘I'm here’). The next evolution of location-based services allowed for users to append location to a particular action (e.g. Twitter or Facebook—I'm here and this is what I'm saying’). The next iteration of location-based services facilitated the sharing of visual points of reference using the medium of sight and/or by being physically present at such a location as the key indicator by a user of where they are (e.g. Instagram—a location based photo sharing application which facilitates the combination of photos and location—‘I'm here and this is what I'm seeing’).

As people turn to their portable electronic devices as their primary means of playing music or other audio metadata, there is a demand for another medium of location contextualization (e.g. ‘I'm here and this is what I'm listening to’). As mentioned, such portable electronic devices are capable of capturing the location of a user at any given point in time. Despite this advance in technology, the media of music or other audio metadata has not been contextualized by location in any significant manner. As described in further detail below, the current embodiment detailed herein is an efficient and important solution to this problem.

This issue is even more apparent in the era of digital music as physical music sales continue to decrease. Before this transition, consumers could easily track what music was popular in various locations by checking the album or single charts for that location. Such charts were based on the number of units sold within that set area. Music charts today are not an accurate reflection of what people are listening to because such sales only represent a fraction of what is actually being listened to. Other consumers may be downloading digital music files (both legally and illegally), using Internet radio providers, cloud lockers or subscription streaming services. This fragmentation has led to a lack of visibility for consumers who can no longer work out with any degree of accuracy what music is popular in certain locations due to the limitation of the related art.

Accordingly, there exists a need for a system and method to locate and notify a user of the music or audio metadata.

### SUMMARY

The invention provides a system and method, as set out in the appended claims, for locating and notifying a user of the music or other audio metadata matching the user's stated preference by appending location information to such metadata.

Many owners of portable electronic devices have their own collection of music which is often sourced from a variety of different locations and music services including, but not limited to mp3 files, mp4 files, other downloads and streaming services. It is very common for electronic devices to be used in a manner that allows the user to side load their music, to store it and play such music. The metadata related to the playing of such audio and music content is therefore accessible as it sits agnostically on an electronic device.

The invention specifically targets this information through a service which interacts with a user's electronic device and is able to access this metadata at the time of playing the content so that it is possible to know what music or other audio content people are actually listening to in real-time.

In addition, once some music or audio metadata has been played by a user, the invention determine the location of the electronic device through the use of either GPS, wireless triangulation, system networks, IP address or a combination of same. This means that it is also possible to find out the location of where such music or audio metadata is played on an electronic device. The invention specifically targets this information appending the location where the music or other such audio metadata was played.

It is also possible to know the exact timestamp of when music or other audio metadata is played on the majority of electronic devices. The invention also takes the timestamp of when such metadata is played on the electronic device.

By combining the music or such other audio metadata with the location and timestamp, the invention can therefore aggregate what is being played and where in real-time. Therefore if a user wants to find out what music is the most played in San Francisco over the previous day, month or year, the invention provides a system and method for locating and notifying a user of the music or other audio metadata matching the user's stated preference.

Furthermore, by aggregating these three variables (e.g. the metadata, location and time), the invention provides bespoke charts for any given area in which the invention has been used. In one embodiment the invention provides a Top 20 (most played) for a continent such as North America and filter this easily by genre and time.

Conversely, assuming the location is retrievable through GPS or some other accurate location retrieval method, the invention can provide the location of what music or other such audio metadata is being listened on a micro-level at a street or even building wide scale. Users can therefore work out what the most played songs are in their local gym are and create a playlist accordingly based on the most listened to songs in that location.

The present invention is an improvement over conventional location-based information systems in that the system and method for providing a location-based and preference-based system that matches the specific expressed music or other such audio interests and preferences of a user with a particular place is unique and an improvement over the prior art.

There is also provided a computer program comprising program instructions for causing a computer program to carry out the above method which may be embodied on a record medium, carrier signal or read-only memory.

It is therefore an object of the present invention to provide a new and improved matching system and method that connects mobile users with their expressed favorite or desired types of music or audio preferences.

It is another object of the present invention to provide a new and improved matching system and method that uses the exact, stated preferences of the users to allow information to be specifically targeted to users who are the most likely to be interested in the information.

It is yet another object of the present invention to provide a new and improved matching system and method that allows mobile users to use the system by way of multiple platforms.

It is still yet another object of the present invention to provide a new and improved matching system and method that is capable of working with real-time GPS location-based systems as well as pre-loaded mapping software.

Yet another object of the present invention is to provide a new system and method for locating and notifying a user of the music or audio metadata matching the user's stated preference in real-time on an electronic device so that they can now see what songs are trending in various locations from a macro to a micro level.

It is another object of the present invention to provide a new and improved matching system and method by appending location to the playing of any such metadata to facilitate the discovery of new music.

In one embodiment there is provided a method of facilitating the consumption of music or other audio metadata based on a user's stated predetermined preference for a specific area over a set period of time and/or by specific genre of such metadata.

In one embodiment there is provided a method of facilitating the purchasing of music or other audio metadata based on a user's stated predetermined preference for a specific area over a set period of time and/or by specific genre of such metadata.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

The invention will be more clearly understood from the following description of an embodiment thereof, given by way of example only, with reference to the accompanying drawings, in which:

FIG. 1 is a diagram of a system for tracking played content and the location of same on an electronic device.

FIG. 2 is a schematic view of one embodiment of the content sources that are being tracked.

FIG. 3 is a diagram of the server to client interaction that is used to implement an embodiment of the invention.

FIG. 4 is a schematic view of one embodiment of how the service tracks content and the location of the music or audio metadata on the Android platform.

FIG. 5 is a schematic view of one embodiment of how the service tracks content and the location of the music or audio metadata on the iOS platform.

FIG. 6 is a diagram of one embodiment of the network processes involved in tracking the location of the music or other audio metadata on a device.

FIG. 7 is a diagram of one embodiment of the hardware processes involved in tracking the location of the music or other audio metadata on a device.

FIG. 8 is an example of the music map on the application with the current location icon engaged.

FIG. 9 is an example of the music map on the application with draw state enabled over a specific area on the map as chosen by a user.

FIG. 10 is an example of the music map on the application with the corresponding music or other audio metadata returned within the co-ordinates of the location queried.

FIG. 11 is an example of the music map on the application when a user has clicked on a specific song that has been played and tracked within the area queried.

FIG. 12 is an example of the music map on the application zoomed in by a user and showing the results of the music or other audio metadata that has been played and tracked on a micro-level.

FIG. 13 is an example of the music map on the application when a user has clicked on a specific song that has been played and tracked within the area queried.

FIG. 14 is an example of the music map on the application zoomed out by a user and showing the results of the music or other audio metadata that has been played and tracked on a macro-level.

FIG. 15 is an example of the music map on the application when a user has clicked on a specific song that has been played and tracked within the area queried.

FIG. 16 is an example of a list view illustrating what the most recent songs are that have been played in that specific location as chosen by a user.

FIG. 17 is an example of a list view illustrating what the top played songs are that have been played in that specific location as chosen by a user.

FIG. 18 is an example of the music map on the application zoomed in by a user to a country level and showing the results of the music or other audio metadata that has been played and tracked within that country.

FIG. 19 is an example of the music map on the application when a user has clicked on a specific song that has been played and tracked within the area of a country.

FIG. 20 is an example of the music map on the application when a user has previewed a specific song that has been played and tracked within the area of a country.

FIG. 21 is an example of the music map on the application when a user has rated a specific song that has been played and tracked within the area of a country.

FIG. 22 is an example of a song card and the corresponding YouTube video for the relevant song tracked.

FIG. 23 is an example of a song card and the corresponding streaming content for the relevant song tracked.

FIG. 24 is an example of a song card and the corresponding purchase link for the relevant song tracked.

FIG. 25 is a description of some example embodiments of how the location information can be relayed to a user.

FIG. 26 is a schematic view of one embodiment of how the service tracks content and the location of the music or audio metadata on the desktop platform.

FIG. 27 is a schematic view of one embodiment of how the service of the invention tracks content on desktop players.

FIG. 28 is an example of the desktop illustrating a song capture on the Google Play Music platform.

### DETAILED DESCRIPTION OF THE DRAWINGS

A system and method of for locating and notifying a user of the music or other audio metadata matching the user's stated preference by appending location information to such metadata is disclosed.

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

Although several embodiments of the invention are discussed with respect to music or other audio metadata at different devices and from different content sources, in communication with a network, it is recognized by one of ordinary skill in the art that the embodiments of the inventions have applicability to any type of content playback (e.g. video, books, games) involving any device (wired and wireless local devices or both local and remote wired or wireless devices) capable of playing content that can be tracked, or capable of communication with such a device with location-based capabilities built into such a device.

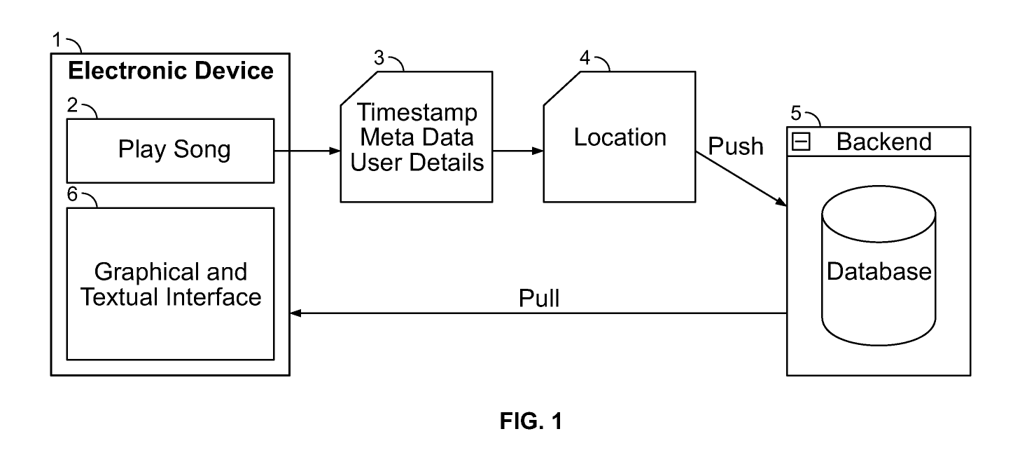

FIG. 1 is a diagram of a system for tracking played content on an electronic device, according to one embodiment and how location information is appended to such metadata at the time of its capture. In various embodiments 1 can be any type of fixed terminal, mobile terminal or portable terminal including desktop computers, laptop computers, handsets, stations, units devices, multimedia tablets, personal digital assistants, cell phones or any combination thereof. Moreover, the device 1 may have a hard-wired energy source (e.g. a plug-in power adapter), a limited energy source (e.g. a battery) or both. It is further contemplated that the device 1 can support any type of interface to the user. By way of example, the communication between push of timestamp, metadata and user details at 3 and location information at 4 between the device 1 and the backend 5 can include one or more networks such as a data network (not shown), a wireless network (not shown), a telephony network (not shown) or any combination thereof. It is contemplated that the data network may be any local area network (LAN), metropolitan are network (MAN), wide area network (WAN), the Internet, or any other suitable packet-switched network. In addition, the wireless network may be, for example, a cellular network and may employ various different technologies including code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS) as well as any other suitable wireless medium (e.g. microwave access (WiMAX), Long Term Evolution (LTE) networks, wireless fidelity (WiFi), satellite and the like.

The system set out in FIG. 1 included a music tracking service 1, 2, 3, 4 and 6 and a database interface process 5. The system includes instructions for finding metadata about music or other audio files and the location of where such content was played together with the timestamp and user details. The backend database 5 is the interface used to retrieve and store metadata, and to retrieve and event data that describes what is being played, where it being played, by whom and when this is being played.

In step 2, the event generator process detects the initial playback of music or other audio metadata on the device. The next step 3 involved the capturing of the user ID associated with the play, the timestamp of when the play was made and the metadata about the content itself (e.g. ID3 tags). An event geolocation message is sent 4 for receipt by the content service system. The geolocation event message indicates the geographic location of the mobile device, determined in any manner known in the art. For example, in some embodiments, the mobile terminal includes a Global Positioning System (GPS) receiver and logic to determine the geographic location of the mobile terminal. This may include GPS, wireless triangulation and system networks or a combination of same such as the Fuse Location Provider as provided by Google. In some embodiments, geolocation message is omitted.

In some embodiments of 3 the user ID field may be used, such as a node identifier for the device used for playback, a user supplied name, an email address or an ID assigned to a user who registers with a content service system (e.g. Facebook). In step 3, the timestamp field is also retrieved which holds data that indicates when the event occurred on the device that plays the content. The content ID in step 2 holds data that uniquely identifies the content being played (e.g. the music or audio metadata). In some embodiments, the field holds data that indicates a name of the content and a name of an artist who generated the content, such as song title and singer name. This content ID, if a music file, often contains the genre of the music played together with the song duration and other related metadata.

In circumstances where the music or audio metadata is not stored on the device 1, often a Content Distribution Network (CDN) (not shown) is the source of the music or audio metadata. Typically, the music store authorizes the CDN to download the client and then directs a link on the user's browser client to request the content from the CDN. The content is delivered to the user through the user's browser client as data formatted, for example, according to HTTP or the real-time messaging protocol (RTMP). As a result, the content is stored as local content on the user's device 1. The local content arrives on the device either directly from the CDN or indirectly through some other device (e.g. a wired note like other host) using a temporary connection (not shown) between mobile terminal for example and other host.

Once this information has been added to the database 5 and stored locally, the application itself 6 on a user's mobile device can then be used to access and retrieve the music or other audio metadata in a graphical and textual interface.

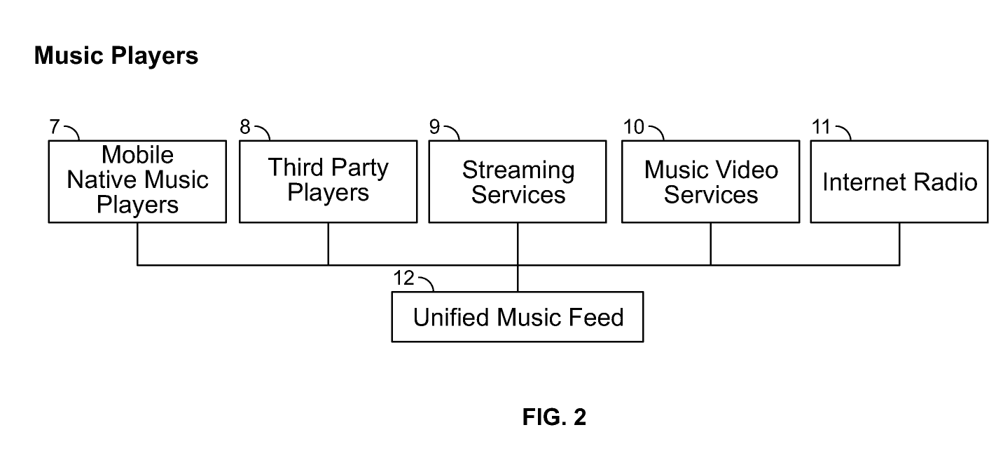

FIG. 2 is a schematic view of one embodiment of the content sources that are being tracked. As set out above, the music or other such metadata can be sourced from either the device 1 itself or from a content provider (not shown). FIG. 2 therefore sets out the different embodiments that can be used in the current art to source such metadata. This includes, but is not limited to, the native music players (e.g. the Android native music player or the iOS native music player) 7. Furthermore, a user may listen to the songs stored on their device 1 using a third party application (e.g. Songbird) which works as both a web app and a bespoke mobile app. In addition, a user may source their music or other audio metadata from a streaming service 9 which provides music on demand (e.g. Spotify). The system in FIG. 1 has been created in such a manner so that it can also track what music or other audio metadata is played using music video services 10 (e.g. YouTube). Finally, internet radio 11 content can also be tracked using the service. The resulting content can then be stored in a unified music feed 12 and displayed in a graphical and textual interface on the application 4. As described above, the geo-location message is pushed from the device 1 at the time the music or other audio metadata is captured (as opposed to from the respective CDN for example), assuming that the device is capable of pushing such a geo-location message.

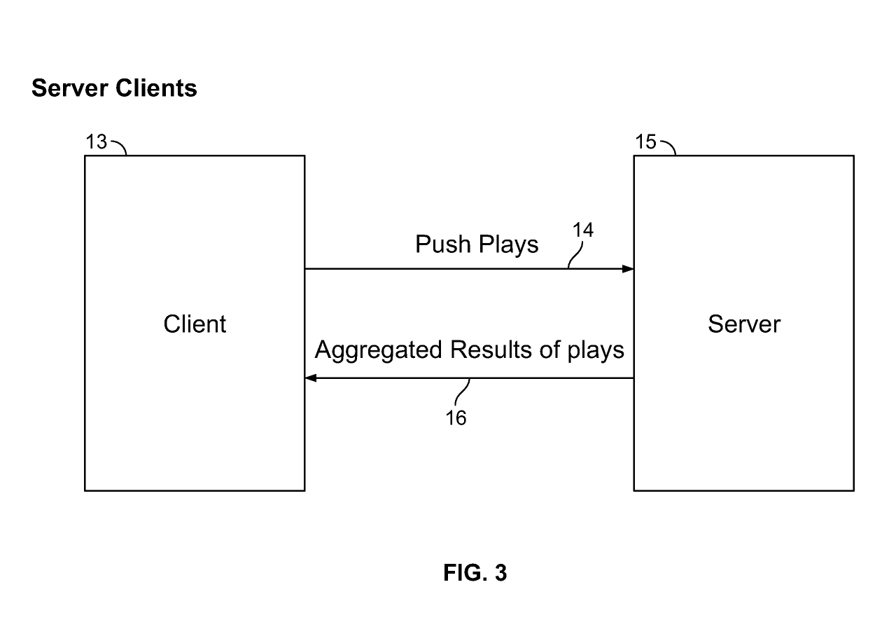

FIG. 3 is a diagram of the server to client interaction that is used to implement an embodiment of the invention. The client-server model of computer process interaction is widely known and used. According to the client-server model, a client process 13 sends a message including a request to a server process 15, and the server process responds by providing a service. The server process 15 may also return a message with a response to the client process 13. Often the client process and server process 15 execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” 13 and “server” 15 refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. In this case, the client 13 pushes plays 14 to the server which then returns the aggregated results of the plays 16 back to the client 13.

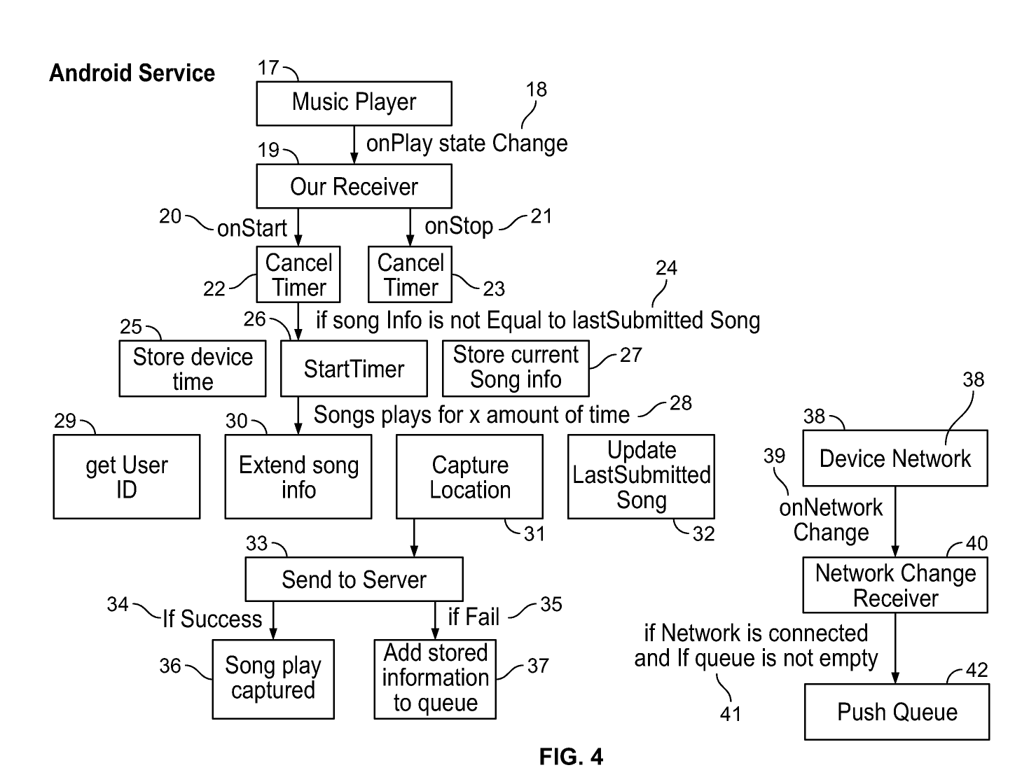

FIG. 4 is a schematic view of one embodiment of how the service tracks content on the Android platform and appends location information to the playing of such content. Taking an example of where the current embodiment is a mobile device, the event begins when the music player 17 is enabled into an onPlay state change 18. This then sends across the respective music or other audio metadata to the receiver 19. In step 20, the system then recognises an onStart state change 20 and the timer is reset 22 as a means of ensuring that new music or other audio metadata begins at a zero count so that step 28 can be queried correctly. Equally, if there is an onStop state change, the timer is cancelled so that the current music or other metadata is not pushed towards the server 33. Step 28 refers to a timer commences on the playback of the content to assess if the metadata has been played for the requisite amount of time. This ensures that only songs that meet the predetermined criteria for a play are tracked. Assuming that the song info is not equal to the last submitted song 24, and that the song plays for the requisite amount of time 28, the device time is stored 25 to assist in providing the timestamp as outlined in step 3. Also, the timer starts again to track the song play duration 26. Furthermore, the current song info is stored 27. If the song plays for the requisite amount of time in step 28, then the extended song info is queried 30 to check the genre of the music or is other audio metadata. Such extended song info 30 is retrieved from the device itself 1. In the next steps, the service then retrieves the user ID 29 and captures the location 31 as outlined previously step 3. This information is then sent to the server 33. Depending on the network connectivity being available, the song play is then captured 36. If the service fails 35, the information is stored and sent to a queue 37 to be pushed at a later point in time.

In circumstances where the device network 38 changes as set out in step 39, the system acknowledges this through a network change receiver 40. Assuming that the network is connected 41 and that there are songs stored in the queue 37, the queue is then pushed in step 42 and the song play is captured as outlined in step 36. It should be noted that the location associated with such metadata that is queued will correspond to the location of where the original push was attempted (as opposed to where the queue is emptied) to ensure a consistency in appending location to the metadata.

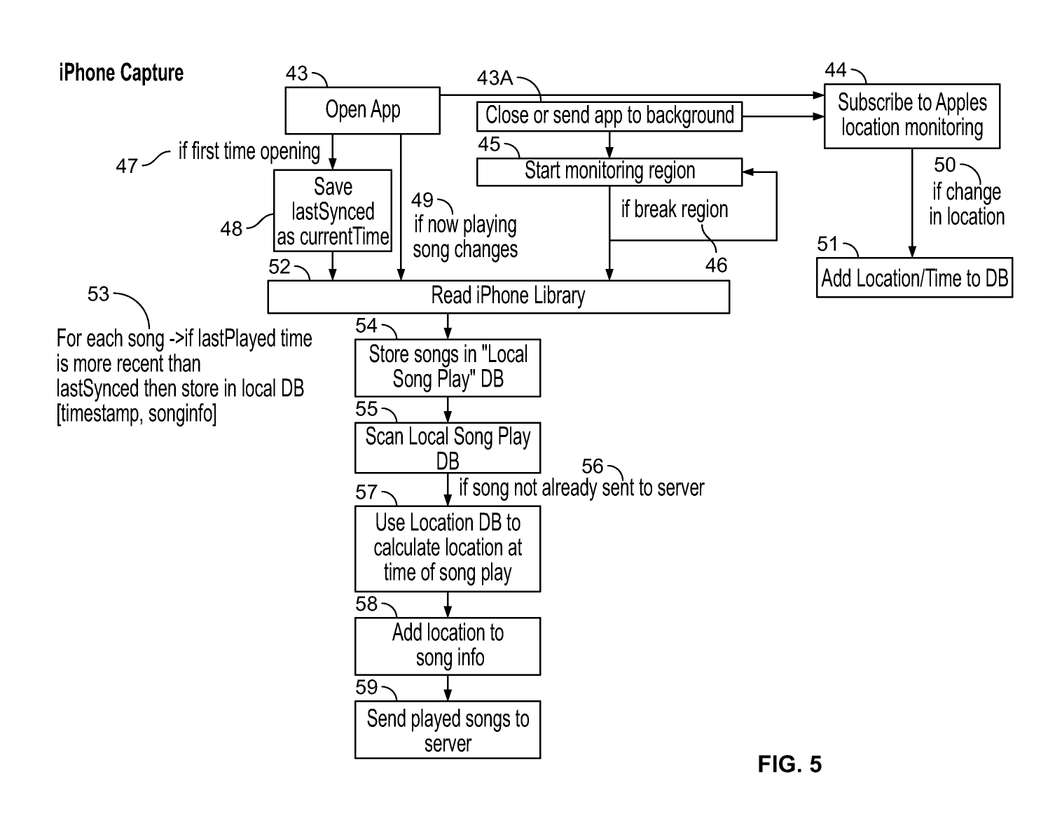

FIG. 5 is a schematic view of one embodiment of how the service tracks content on the iOS platform. Taking an example of where the device 1 is a mobile device, the service begins with one of three possible events (a) either the application is opened 43 for the first time (b) is opened for a second or subsequent time or (c) in cases when the app is closed or dormant in the background 43A.

If the app is opened for the first time 47 the service saves the last synced as the current time 48. The next step involves the iPhone library being read 52 to query what the last played songs have been in the phones library and proceeds to step 53 described below.

If the app is opened (any time after being opened for the first time), the service then checks what the now playing song is and if this has changed 49. If it has, then the service reads the iPhone library 52 and proceeds to step 53 described below.

If the app is closed or if the app is dormant in the background 43A, the service will start monitoring the region 45 of the device 1. If and when the user then breaks the region as outlined in step 46, the service assesses if the now playing song has changed since the last query 49. If the now playing song has changed 49, the service reads the iPhone library 52 and proceeds to step 53 described below. If the now playing song has not changed, the service does not proceed again until the user breaks the region that is being monitored 46. This step will reoccur until the now playing song actually changes.

In addition, the service of the invention subscribes to Apple's location monitoring 44 and if there is a change in location 50, the location and time of this change is added to the location database 51 which is then used to append location to the song play 58 in advance of being sent to the server 59.

For every song queried on the iPhone library, if the last played time is more recent than the last synced 53 then it is stores in the local database 54. An example of this would be when the last sync takes place at 11 am. If the last played song is tracked at 1 pm (which is two hours after the last sync), then the song is stored in the Local Song Play DB 55. Taking another example, if the last played song is tracked at 10 am, then the song will not be stored in the Local Song Play DB 55 as the last sync occurred later than the last played song. The next step involves a scan of the Local Song play Database 55 and if this song has not already been sent to the server 56 it will be sent to the server 59. As outlined above, before step 59, the system uses the location database to calculate the location at the time that the song was played 57. If this query is successful, the location is appended to the song information 58. One unique feature of this embodiment is that if the location cannot be calculated at step 57, the present invention calculates the time of when the song play occurred and triangulates the approximate location by working out the distance between the last two known locations and the time that songs were played at these locations. For the purposes of this FIG. 5, song metadata is just one embodiment of the type of metadata that can be tracked on iOS as this could apply equally to audio files etc.

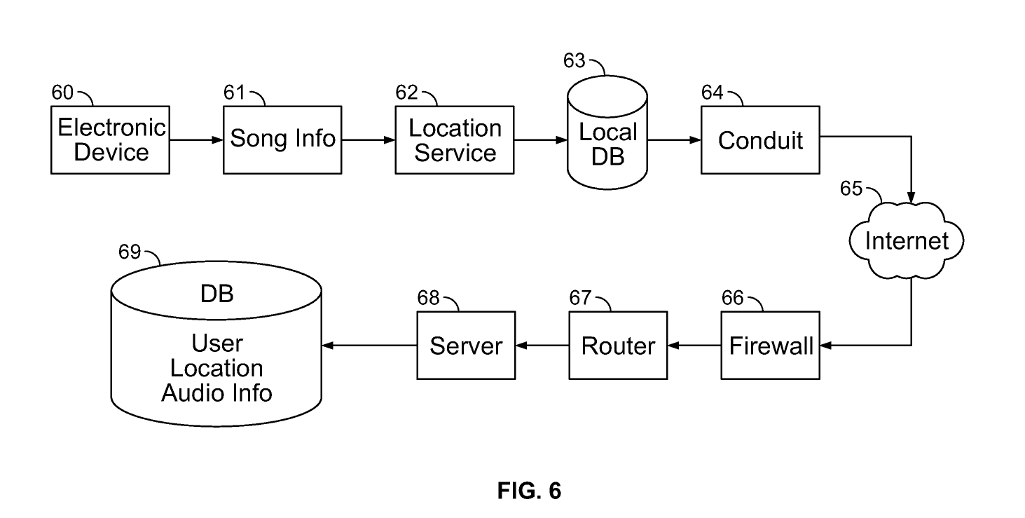

Referring now to FIG. 6, there is shown a preferred embodiment of the hardware components needed for the preference matching system of the present invention. The preference matching system, is shown as having an electronic device 60, a remote server 68 containing or capable of accessing a database of music and audio metadata and location information 69; and a location service 62 for communicating with the GPS satellites (not shown), wireless triangulation and system networks or a combination of same. It is appreciated that the wireless device of the present invention may communicate and receive location-based information from the location services in any known way.

While an electronic device is shown and disclosed, it is appreciated that a wireless device may be any of the known wireless devices including, but not limited to, a wireless-enabled notebook computer, a 2-way pager, a cellular phone, or an integrated vehicular navigational device or any other wireless or hard-wired devices that are capable of playing music or other audio metadata 61. The electronic device 60 preferably, has a local database 63 stored in on-board RAM or ROM such as memory cards so as to contain the preferences of the user and/or the metadata of the music or other audio files. It is also appreciated that the user preferences may be stored on the server or elsewhere and not depart from the scope of the present invention. The electronic device 60 also preferably has GPS capabilities so as to be capable of determining its geographic position by receiving and interpreting the signals of the GPS satellites.

It is appreciated that the server 68 may be capable of being accessed wirelessly through a wireless connection (not shown); by non-wireless connection by way of conventional modem by the electronic device via telephone line and ISP to the Internet 65; or by a land-line connection to a computer or other conduit 64 with TCP/IP access to the Internet 65. A router 67 and firewall 66 are preferably interposed between the Internet and the server for security purposes. It is appreciated that other security measures and devices may be used and not depart from the scope of the present invention. A server farm is preferably used for the proprietary socket server (both clustered and redundant), as well as for web serving the application's user interface (both clustered and redundant).

While it is appreciated that a wide variety of software may be used, the preferred software is: portable GPS receiving software such as NMEA 0183 Protocol supported software; a profile matching application; Berkeley/Winsock socket server software for both the wireless device and the non-wireless device embodiments; TCP/IP access software; COM/DCOM or J2EE Compliant web server software; and an ANSI/ISO SQL database management system such as an SQL server 2000 or an Oracle® 9i database management system. The server farms for the socket server preferably run Windows® 2000 Advanced Server or better and Linux® or Solaris with J2EE web application software.

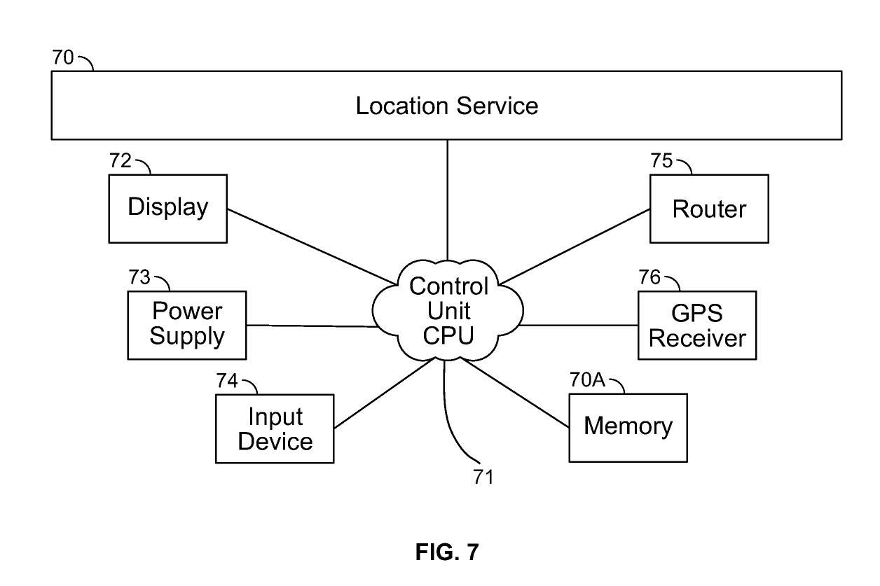

Referring now to FIG. 7, the preferred hardware for an electronic device for use in the present invention is shown. The electronic device preferably includes: a control unit including a CPU 71; an input/output system (I/O system) 74 and 72 controlled by the CPU 71; a location determination system such as a GPS receiver 76 and associated software; on-board memory 70A for data storage; location service capability 70; a router 75 or other wireless or hardwired modem (not shown) for accessing the Internet. The I/O system of the electronic device preferably includes an input device 74 and a display 72 such as an LCD or retina display screen to interface between the user and the electronic device. The input device 74 may be, but is not limited to, a touch pad, an on-screen keyboard, a touch screen, a mouse, or a speech recognition device. The board memory 70A for storing the personalized information of the user and/or the music or other audio metadata may be, but is not limited to, EPROM, flash memory, disk drive, or other suitable recordable storage media.

If a wireless TCP/IP or similar connection is available for the electronic device, the electronic device can download the requisite user preference profile and/or person, music or other audio metadata in real time from the remote server. If a connection is not available, then the requisite user profile and/or music or other audio metadata can be preloaded or downloaded into the Local Database or a separate database of the electronic device at a time when such a connection is available.

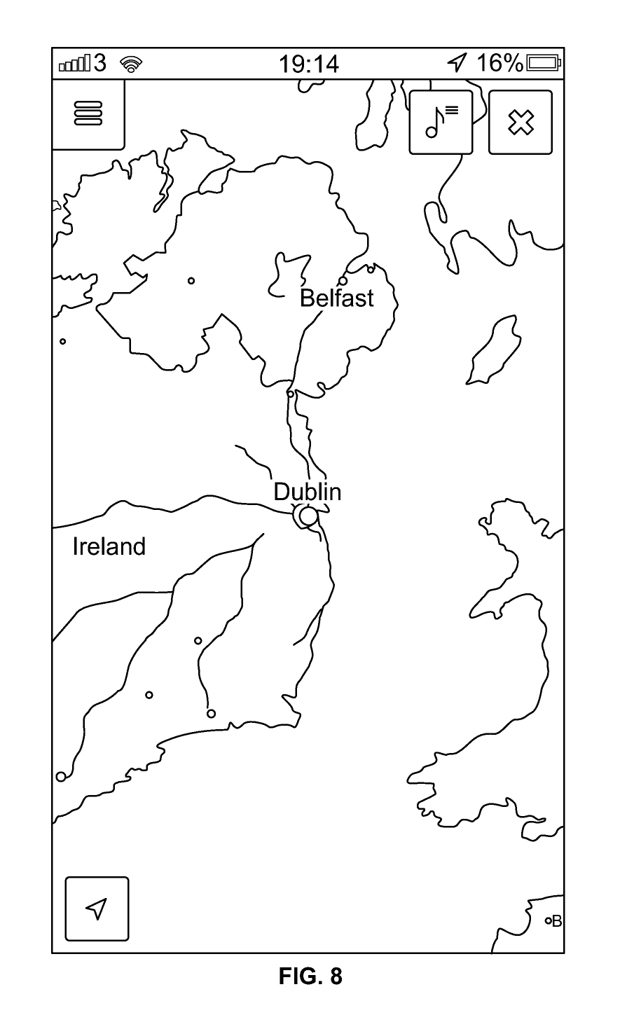

Referring now to FIGS. 8 through 11, a plurality of screenshots illustrating one embodiment of point of information exchange through a map providing a mechanism to locate and notify a user of the music or other audio metadata matching the user's stated preference by appending location information to such metadata.

Through the point of interest exchange, which preferably is incorporated into the system in real time for access by others, users may review the music map as displayed graphically and textually 6 in the present invention and see what music or other audio metadata has been listened to in that specific area.

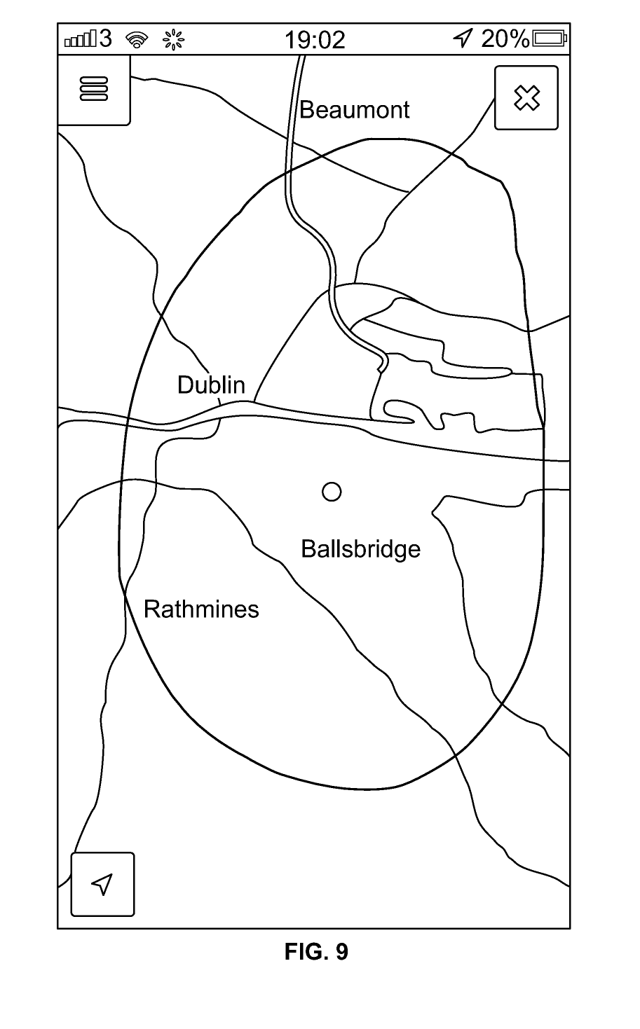

FIG. 8 for example shows the example of the first step in locating and notifying a user of the music or other audio metadata matching the user's stated preference, which in this case, is by activating the current location icon on a map. Accordingly, the use's current location is tagged and the map adjusts accordingly (over Dublin, Ireland in this case). The next step is set out in FIG. 9 which is an example of the music map on the application with draw state enabled over a specific area on the map as chosen by a user (e.g. Dublin, Ireland in this case). In the present embodiment this location is determined by a user drawing a polygon using their finger on a touch screen. As set out below, this polygon can therefore be drawn over as small or as large an area as requested by a user's stated preference.

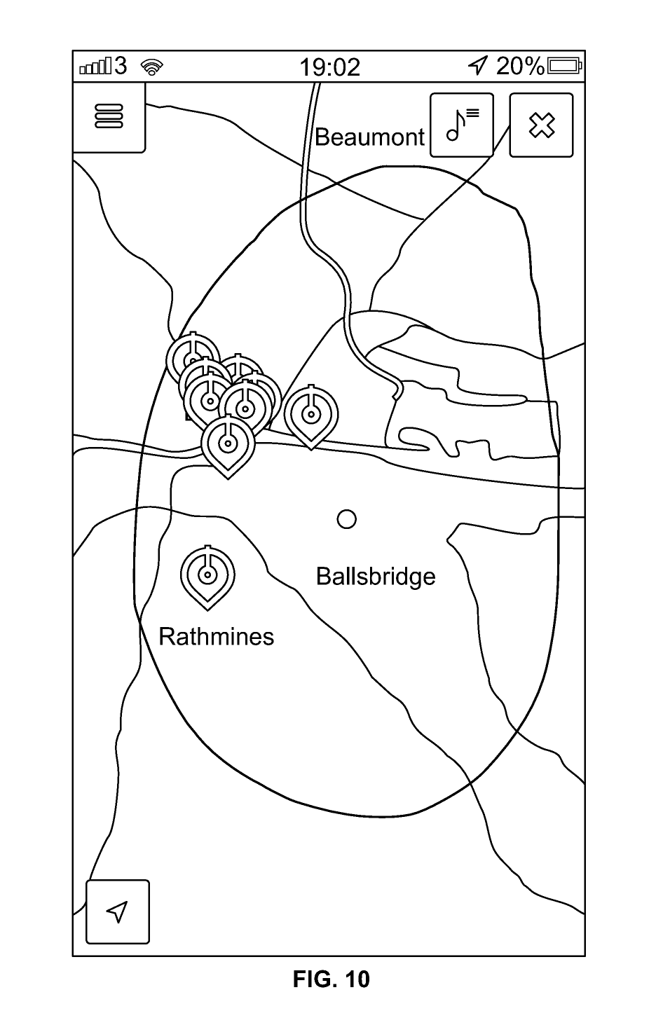

In FIG. 10, a screenshot example of the music map on the application is shown with the corresponding music or other audio metadata returned within the co-ordinates of the location queried. As described in FIGS. 1 through 7, when music or other audio metadata is played, the location of where that song was played is also appended in the present invention. FIG. 10 clearly shows how the location of such metadata is then displayed in a graphical and textual format when queried by a user.

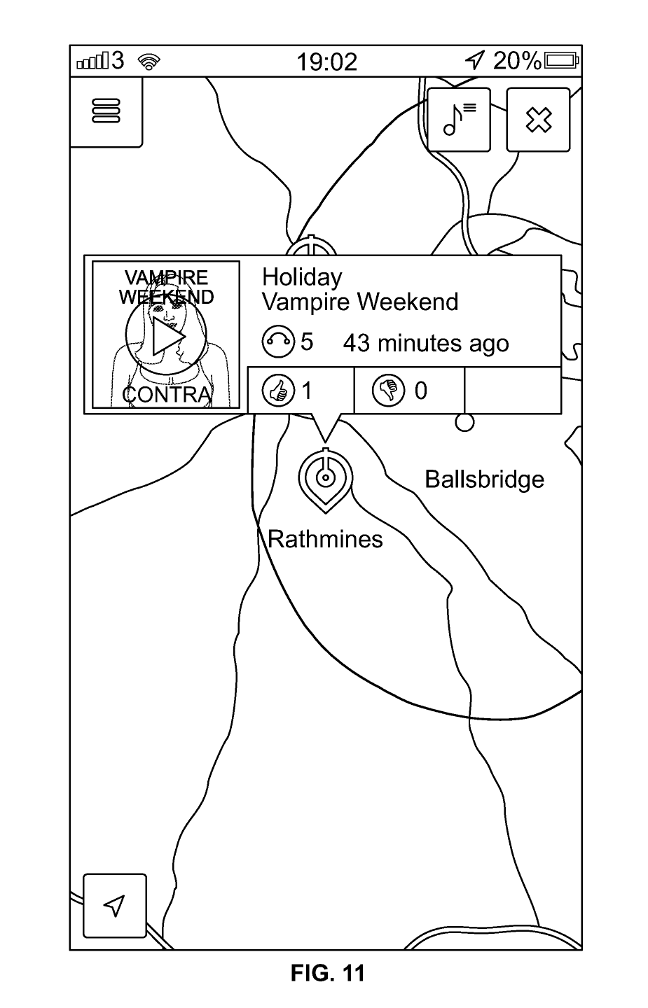

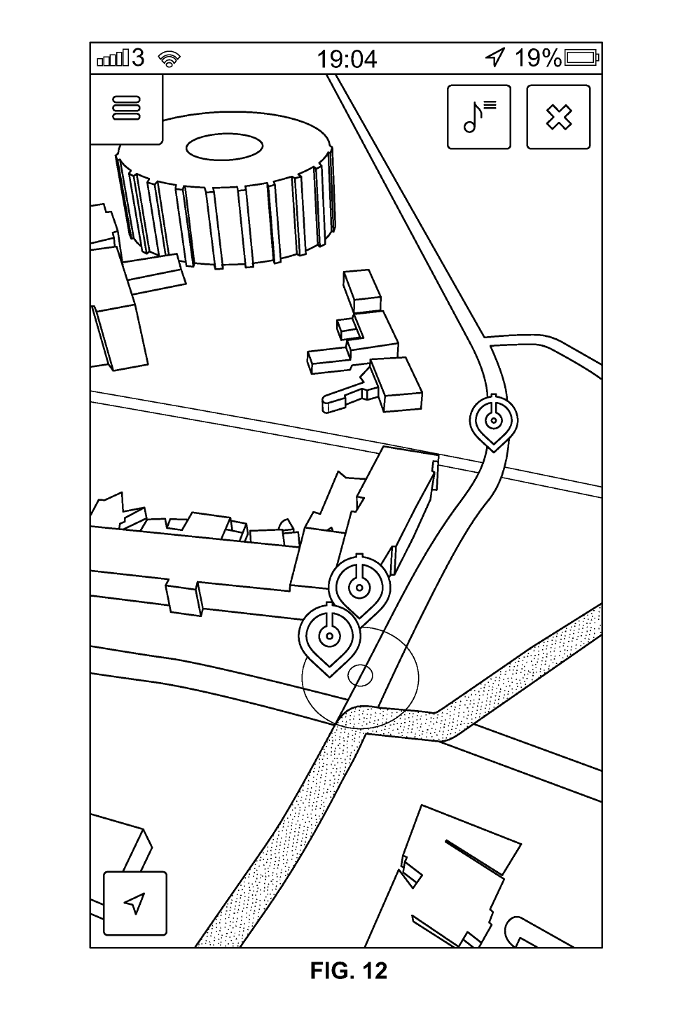

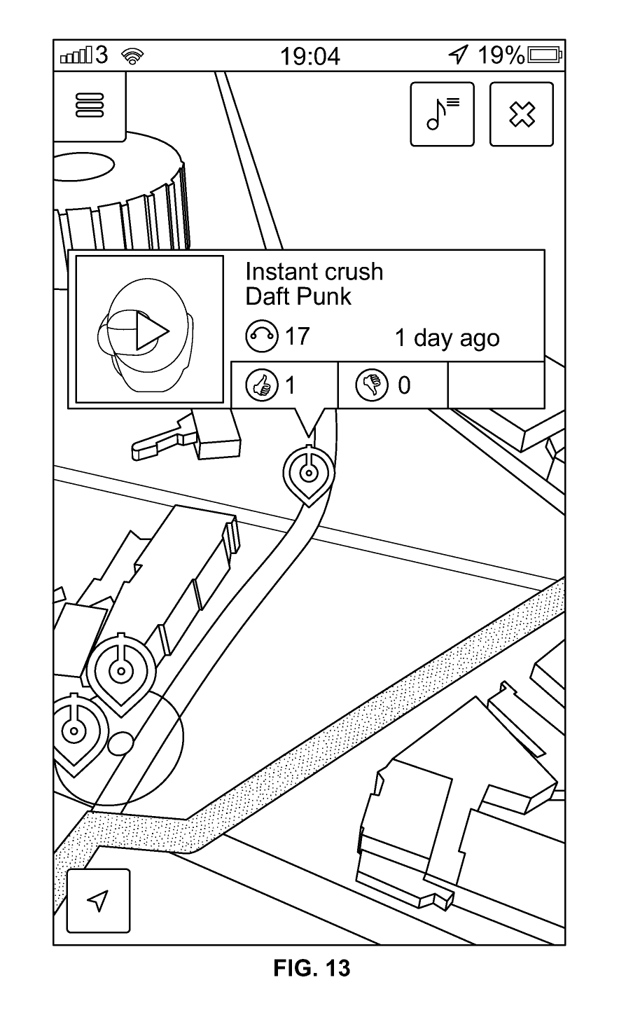

Referring now to FIG. 11, this is an example of the music map on the application when a user has clicked on a specific song that has been played and tracked within the area queried. In this case the song ‘Holiday’ by Vampire Weekend is returned for that specific location pin. FIG. 12 is an example of the music map on the application zoomed in by a user and showing the results of the music or other audio metadata that has been played and tracked on a micro-level. For example, in the current embodiment, the user has stated their preference at a street or building-wide scale search for music or other audio metadata within Dublin city, Ireland. FIG. 13 is an example of when said user has clicked on a specific song that has been played and tracked within the street or building-wide scale search for music or other audio metadata. In this case the song ‘Instant Crush’ by Daft Punk is returned for that specific location pin. This allows a user to see what music or other audio metadata has been played to a high degree of accuracy either within their own vicinity or anywhere else on a map. In some embodiments, results for this micro-level search will be null if no songs have been tracked in that specific area.

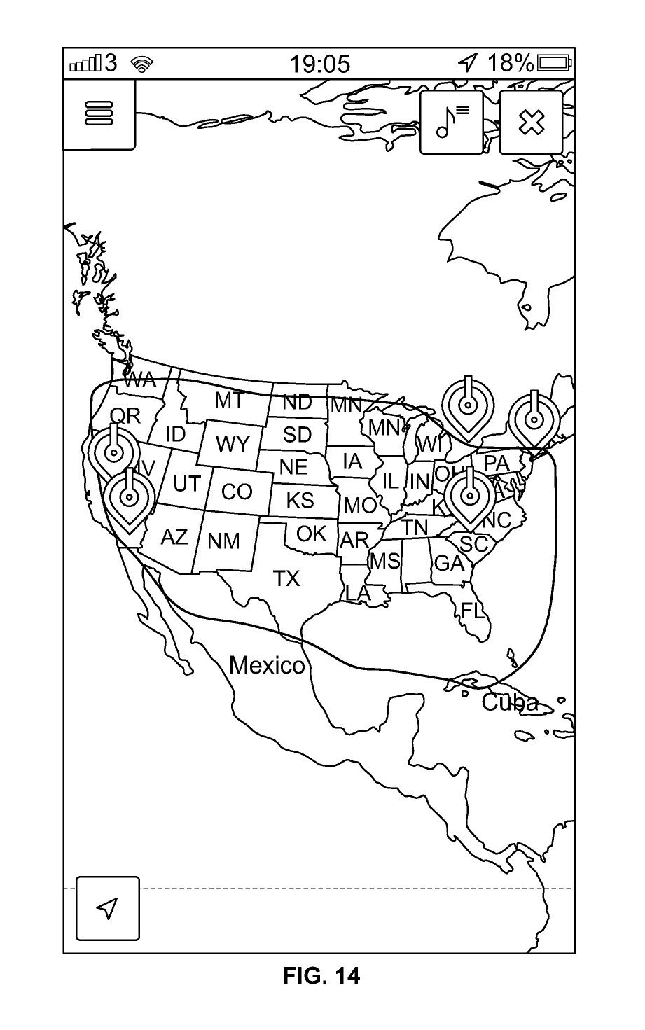

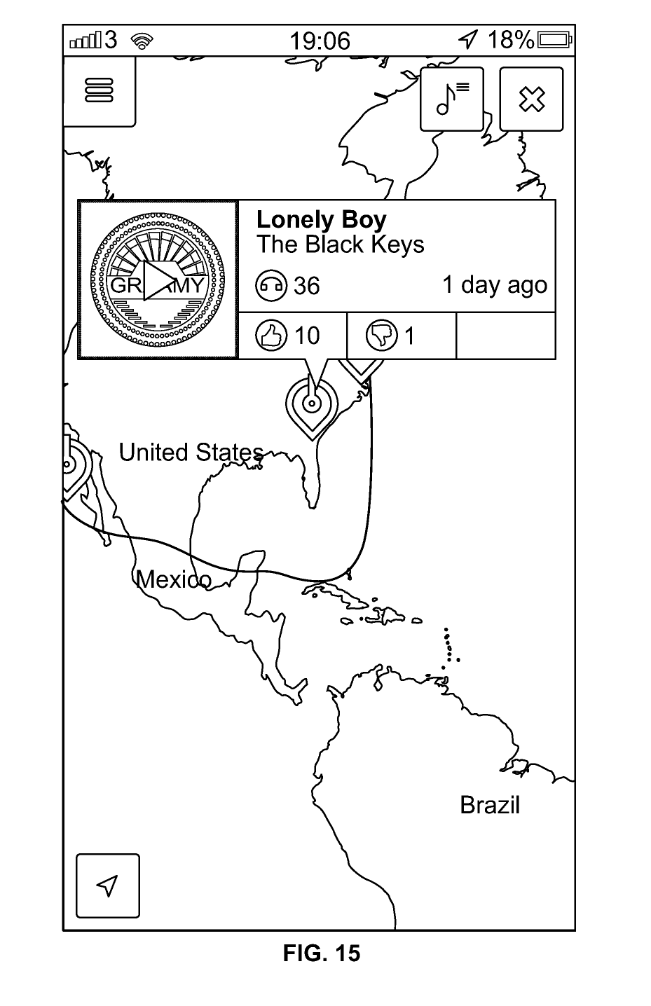

FIG. 14 is an example of the music map on the application zoomed out by a user and showing the results of the music or other audio metadata that has been played and tracked on a macro-level. For example, in the current embodiment, the user has stated their preference at continent-wide scale search for music or other audio metadata over North America. FIG. 15 is an example of when a user has clicked on a specific song that has been played and tracked within the continent-wide scale search for music or other audio metadata. In this case the song ‘Lonely Boy’ by the Black Keys is returned for that specific location pin.

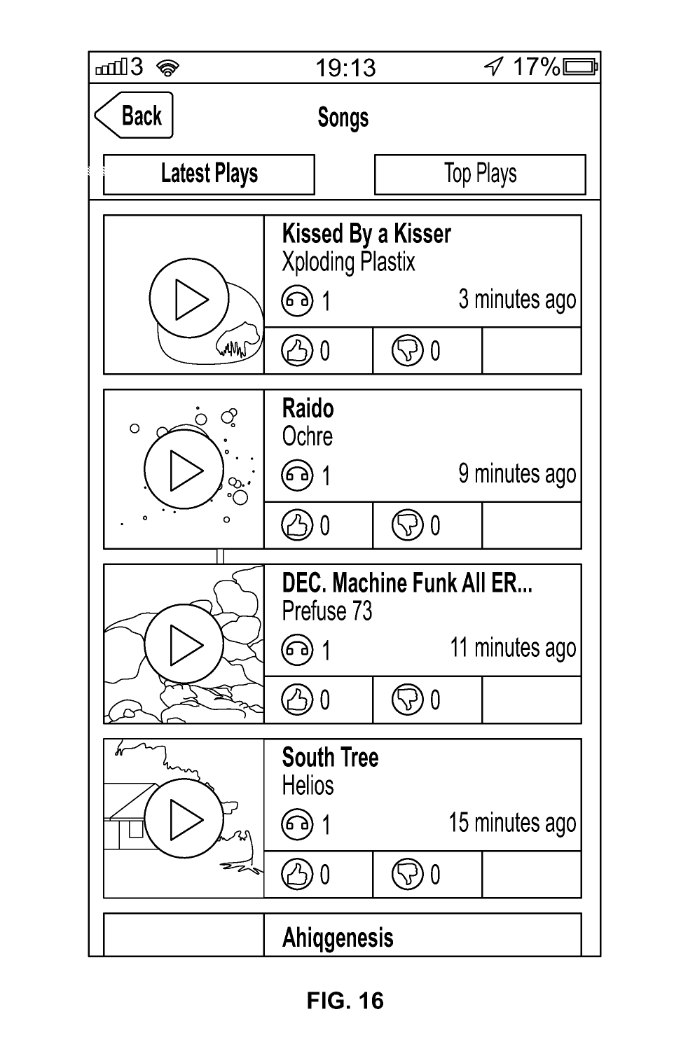

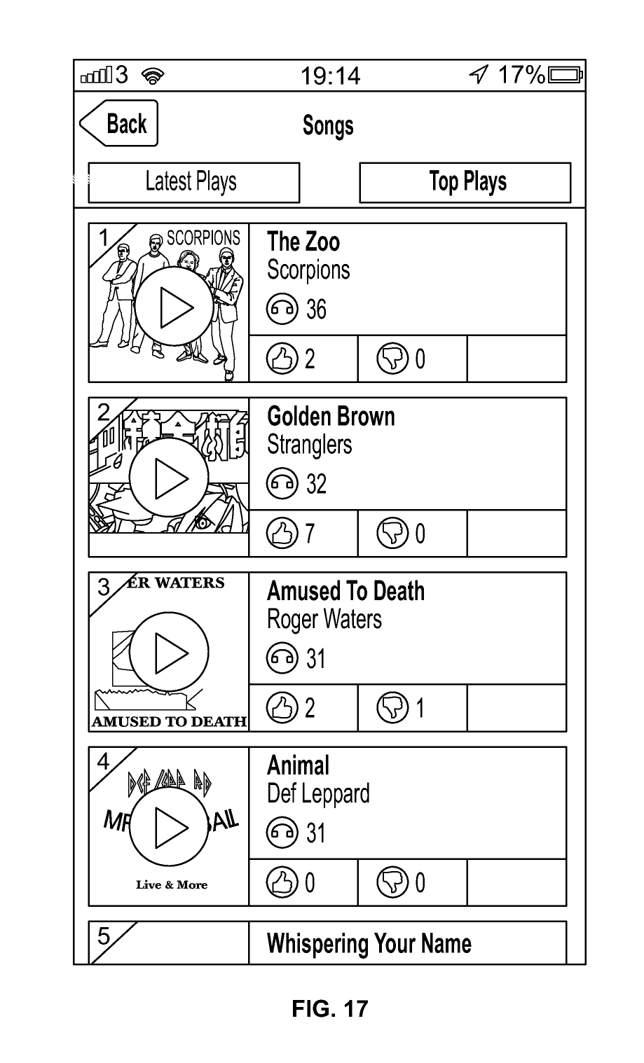

FIG. 16 is an example of a list view illustrating what the most recent songs are that have been played in that specific location as chosen by a user. By way of example, if a user chooses the area of San Francisco, as their stated location preference, the present invention provides the user with a textual list of what the latest played songs are within that stated preference. FIG. 17 is an example of a list view illustrating what the top played songs are that have been played in that specific location as chosen by a user. Again, by way of example, if a user chooses the area of San Francisco, as their stated location preference, the present invention provides the user with a textual list of what the most played songs are within that stated preference. As will be outlined in further detail below, this allows for the creation of bespoke charts for both the latest trending songs in an area and the most played songs in an area.

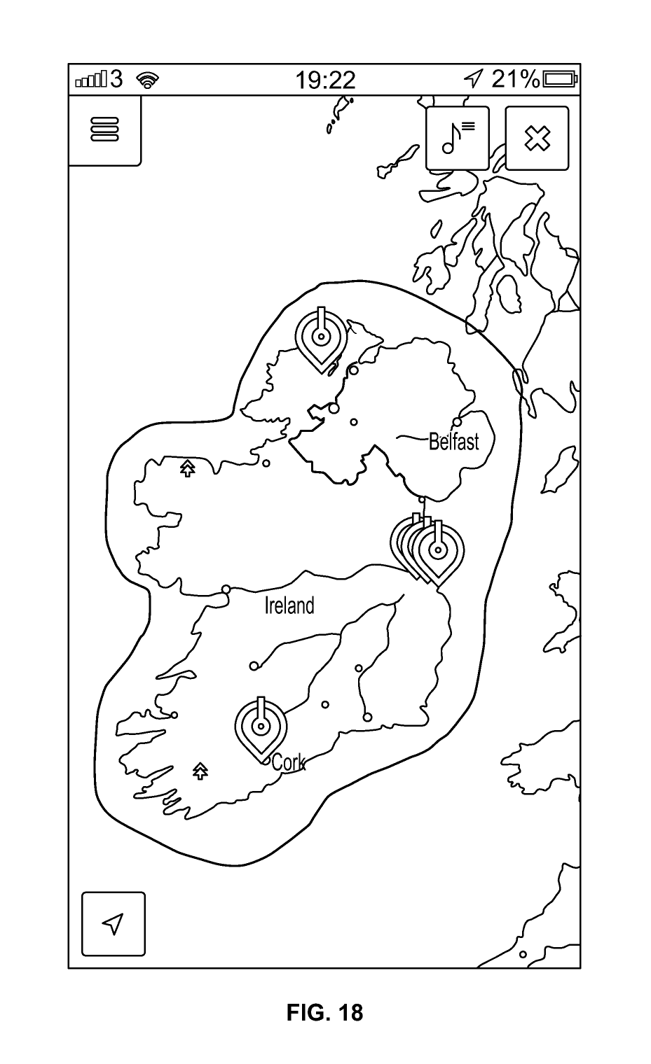

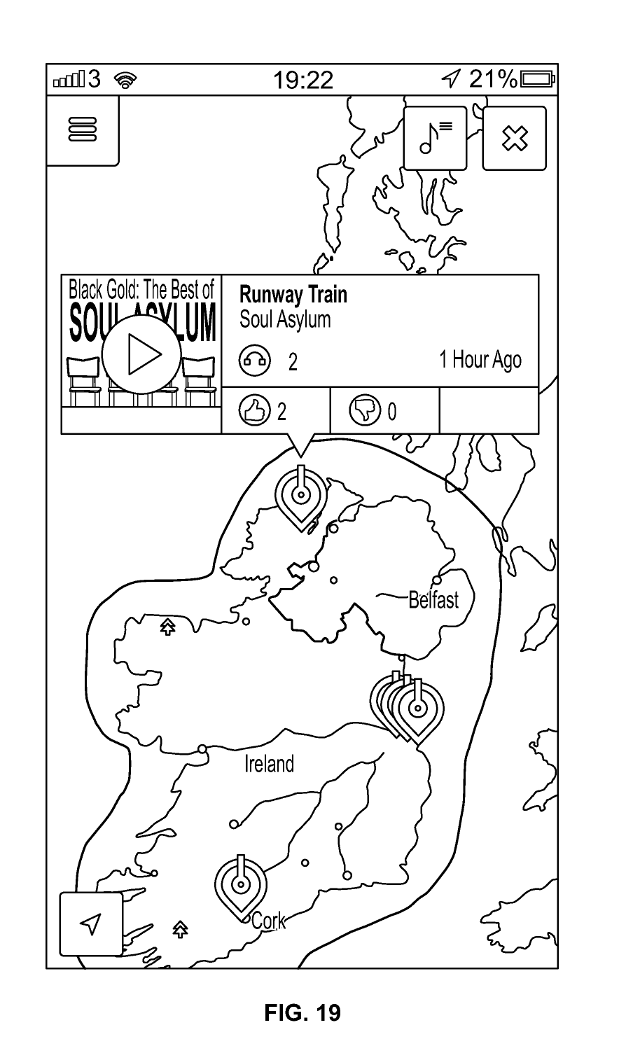

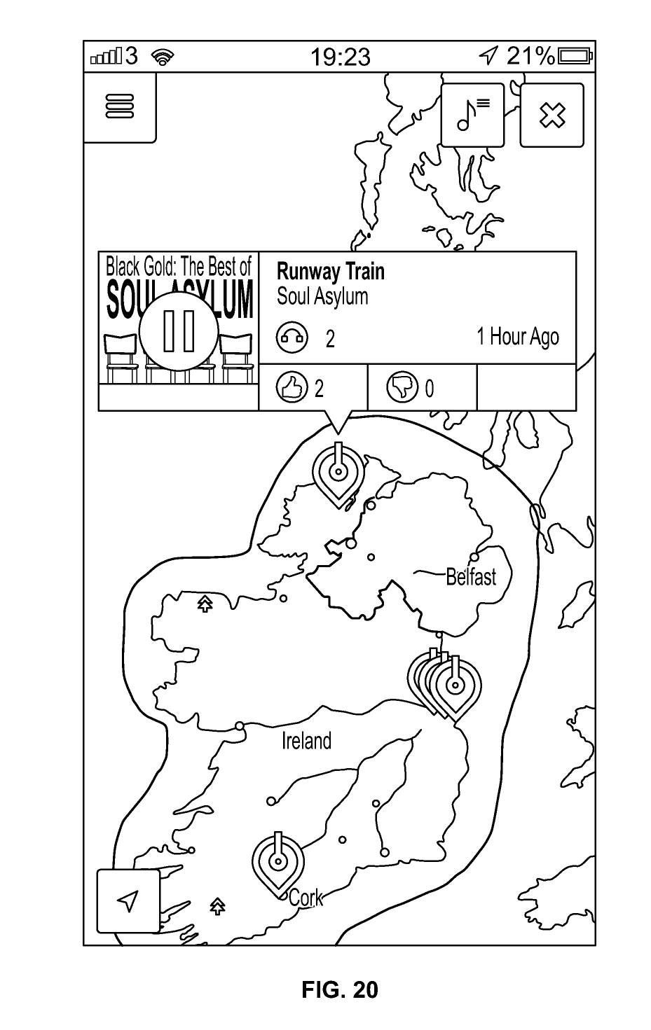

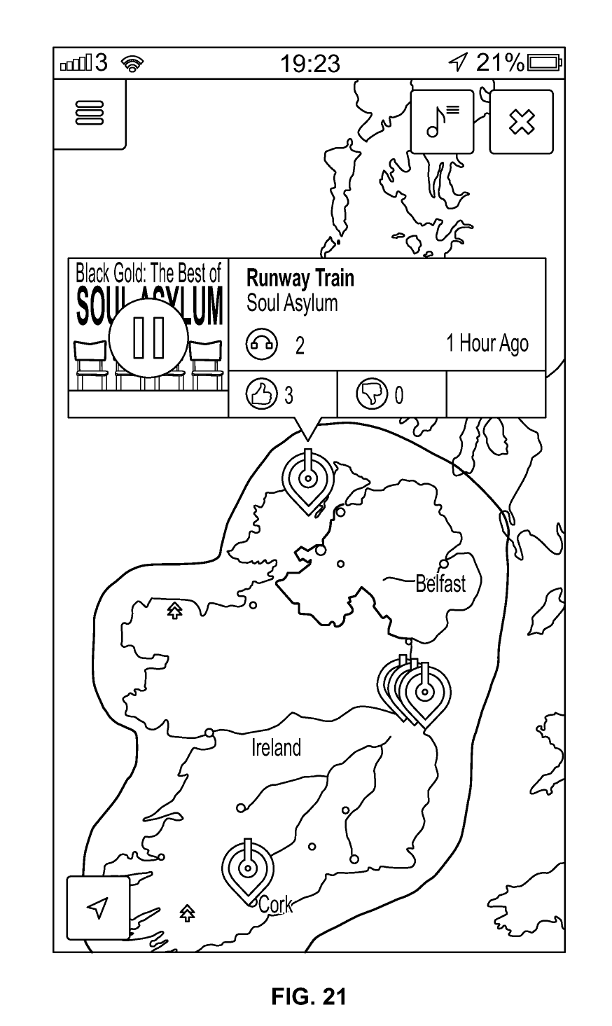

FIG. 18 is another example of the graphical and textual interface zoomed in by a user to a country-wide level (Ireland in this case) and showing the results of the music or other audio metadata that has been played and tracked within that country. FIG. 19 is an example of the music map on the application when a user has clicked on a specific song that has been played and tracked within the area of a country. FIG. 20 is an example of when a user has previewed a specific song that has been played and tracked within the area of a country (e.g. a 30 second preview can be streamed directly from the map interface itself so that a user can listen to the specific music or other audio metadata clicked on). FIG. 21 is an example of when a user has rated a specific song that has been played and tracked within the area of a country. Referring to FIGS. 19 through 21, the song ‘Runaway Train’ by Soul Asylum is located and notified to the user who can then preview this song on the same screen and rate it (e.g. like or dislike it amongst the social network or other conveyance system).

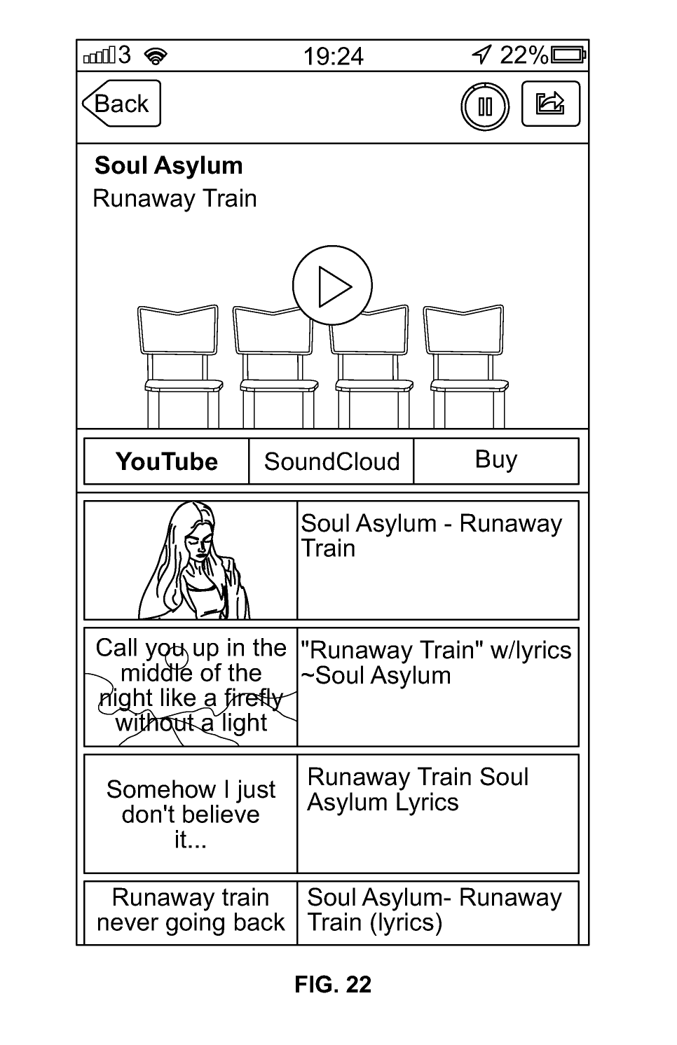

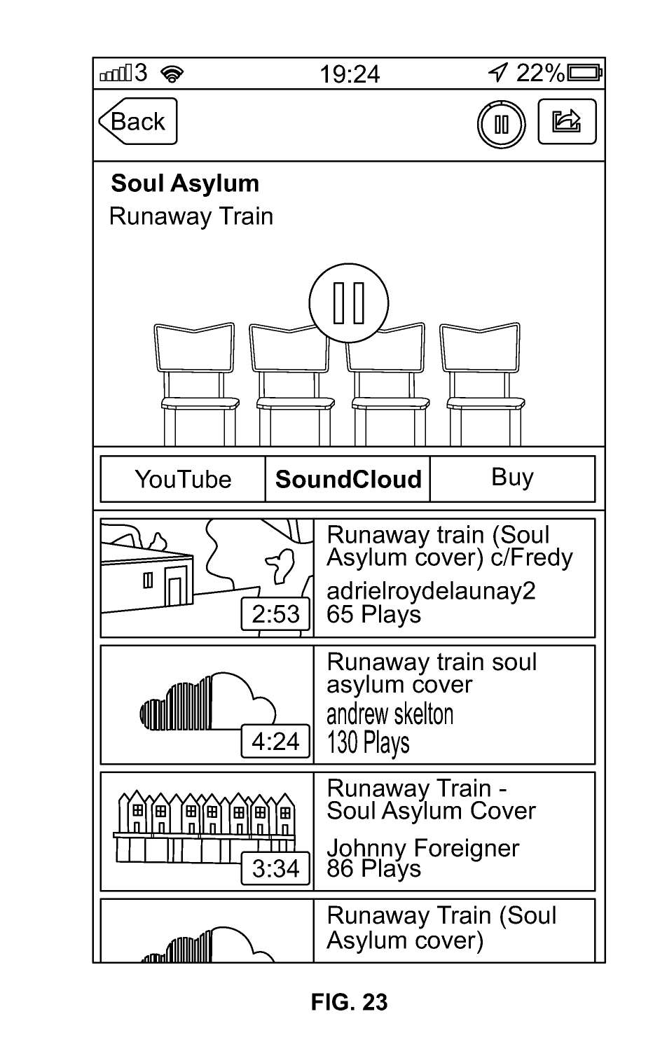

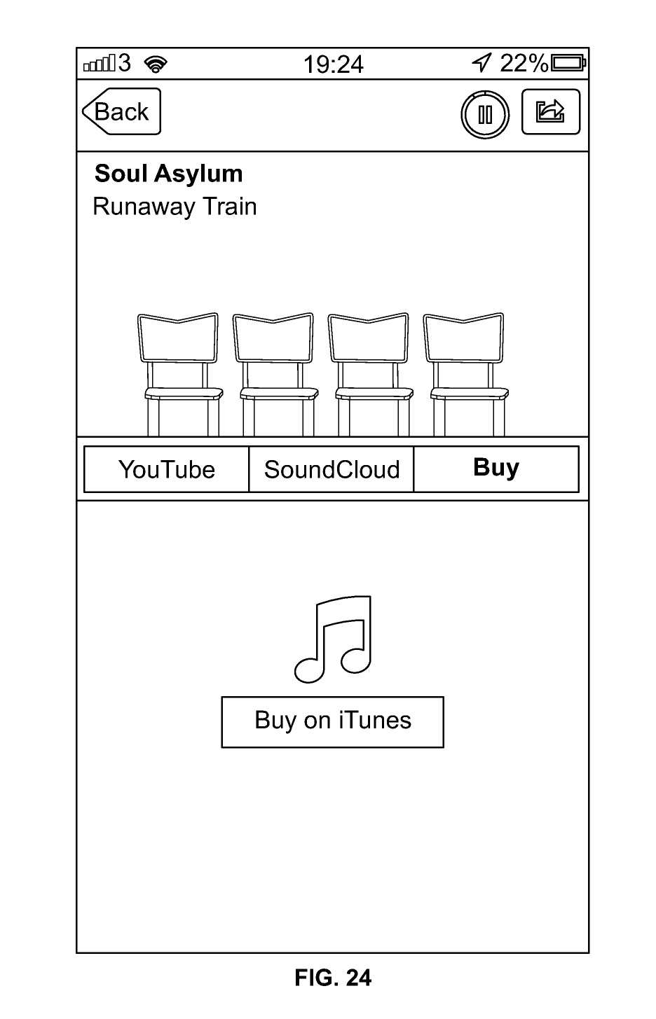

In addition to previewing the song, the present embodiment allows a user to watch a video of the full song using YouTube as illustrated in FIG. 22. Furthermore, FIG. 23 is an example of a how a user can stream the full content for the relevant song tracked. Referring to FIG. 24, this is an example of a song card and how the corresponding purchase link for the relevant song tracked is available to the user. Referring to FIGS. 19 through 21, the song ‘Runaway Train’ by Soul Asylum is can therefore be clicked on from the music map and a separate song card (for that song) provides a mechanism for the user to watch the video, stream the full song or buy it, all within the present invention.

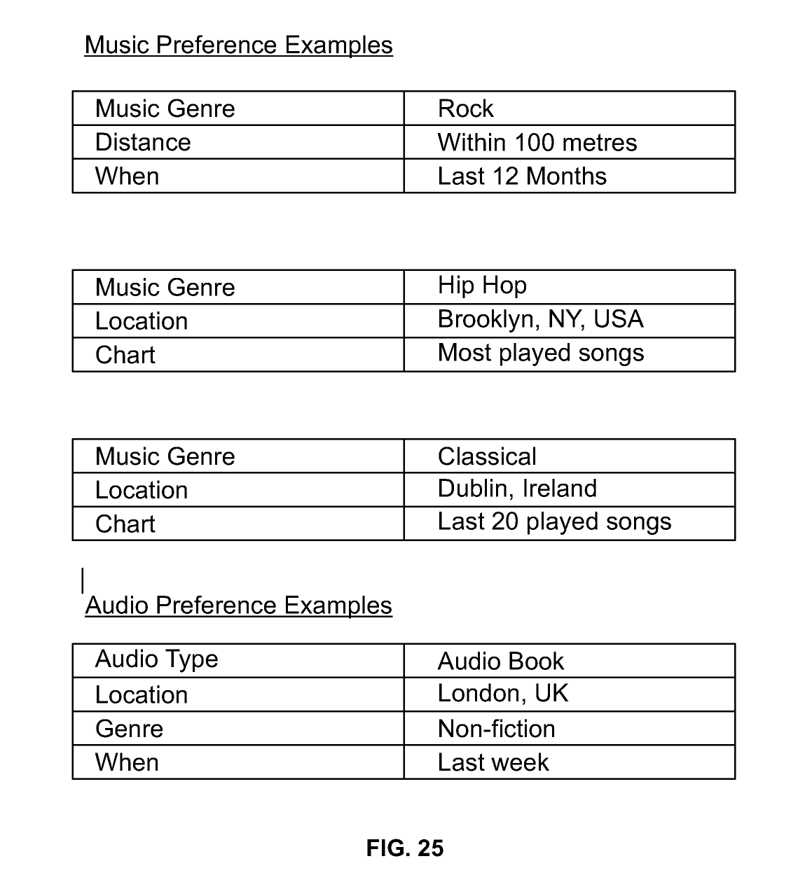

FIG. 25 is a description of some example embodiments of how the location information can be relayed to a user in respect of music metadata preferences and audio metadata preferences. As outlined in steps 3 and 4 of FIG. 1, the timestamp, ID3 tags and user ID can be used as filters for any specific location. In the present example, a user could therefore search for music by a specific genre over a certain time frame and within a certain distance. In this case, Rock music, within 100 metres over the last 12 months. Equally, a user can state their preference for bespoke charts of a certain genre type over a specific timeframe in any given location. The present examples include a most played chart for Hip Hop music in Brooklyn and the most recent top 20 chart for Classical music in Dublin, Ireland. Finally, it is also possible to track other audio metadata such as audio books. In the present example, the user's stated preference is for non-fiction audio books in London, UK played during the previous week.

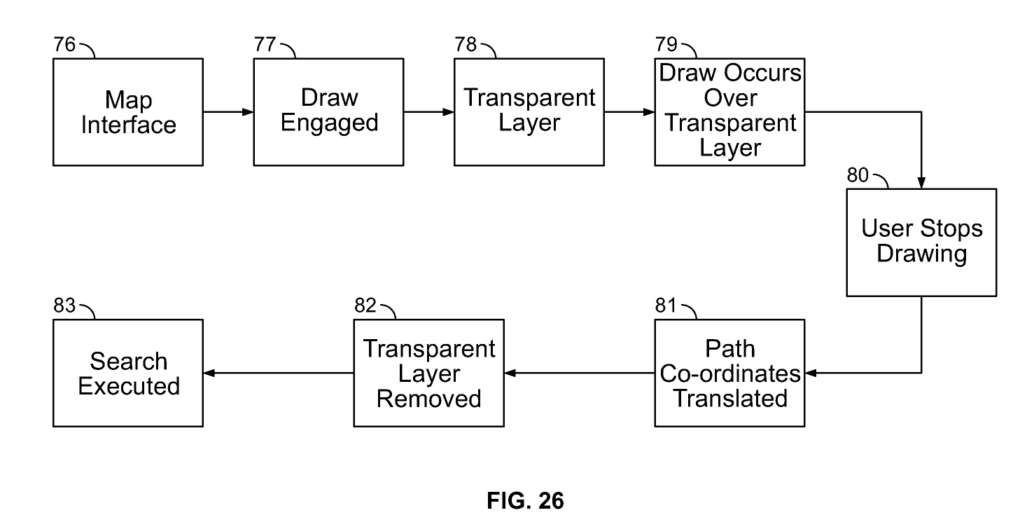

FIG. 26 is a schematic view of the mechanism used to connect the map overlay used in the music map with the touchscreen display on an electronic device in order to allow a user to search for location specific preferences by drawing on the map. In this example, the user can manipulate the map interface 76 (e.g. zoom in, zoom out, scroll or click on the current location icon). Once the stated preference area has been selected, the user can then engage the draw functionality 77 in the present invention by tapping on it. In the background, and before the next step, a transparent canvas layer is then introduced which is added above the map 78. It is on this canvas layer that the user actually draws on (as opposed to the map interface itself 76). In the current embodiment, the user then draws a shape on the transparent canvas layer 79. When the user stops drawing 80, the path co-ordinates are translated to geo-location coordinates on the map interface and a polygon is automatically drawn on screen 81. The transparent canvas layer is then removed in the background 82. A search is then extended to load songs within the specified polygon and the corresponding results, as outlined above, are displayed to the user (either graphically or textually). The present embodiment is just one example of how a user can search for a stated preference using a map interface and touch screen. Many other variations of this interchange, such as alternate reality and Google glasses for example, could equally be used to locate and notify a user of the music or audio metadata matching a user's stated preference.

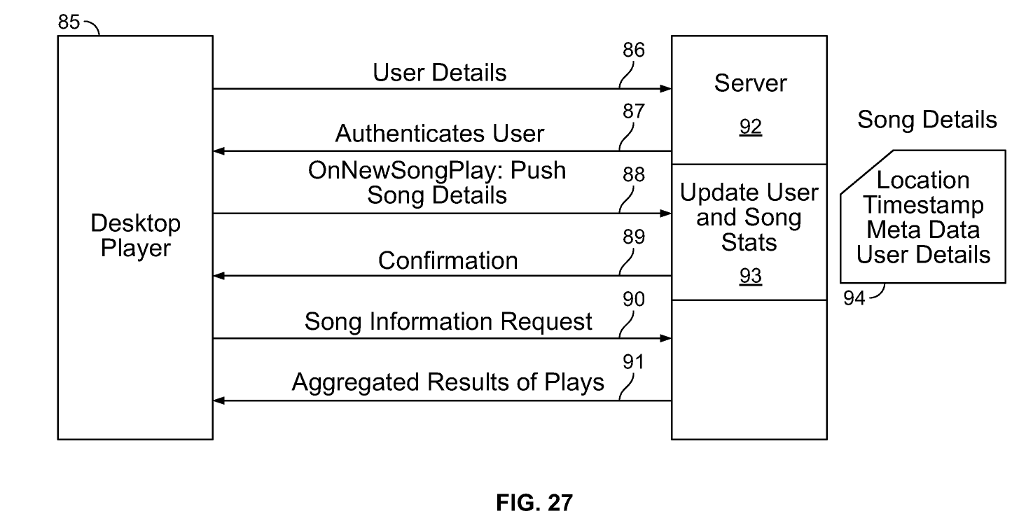

FIG. 27 is a schematic view of one embodiment of how the service of the invention tracks content on desktop players. The event begins when the user details 86 are sent across to the server 92 and are authenticated 87. If the desktop player 85 is enabled into an onPlay state change then the song details are then transmitted to the server 88. A confirmation request is then pushed by the server 89 which then relays the song information request 90 that provides an aggregated result of all plays on the desktop 91. The server updates the user and song stats 93 based on the song details provided (location, timestamp, metadata and user details) 94. This ensures that song captures from the desktop device are synced with any other song captures from mobile devices for example and ensures that a users entire listening history is captured irrespective of whether the song is listened to on a desktop or mobile device.

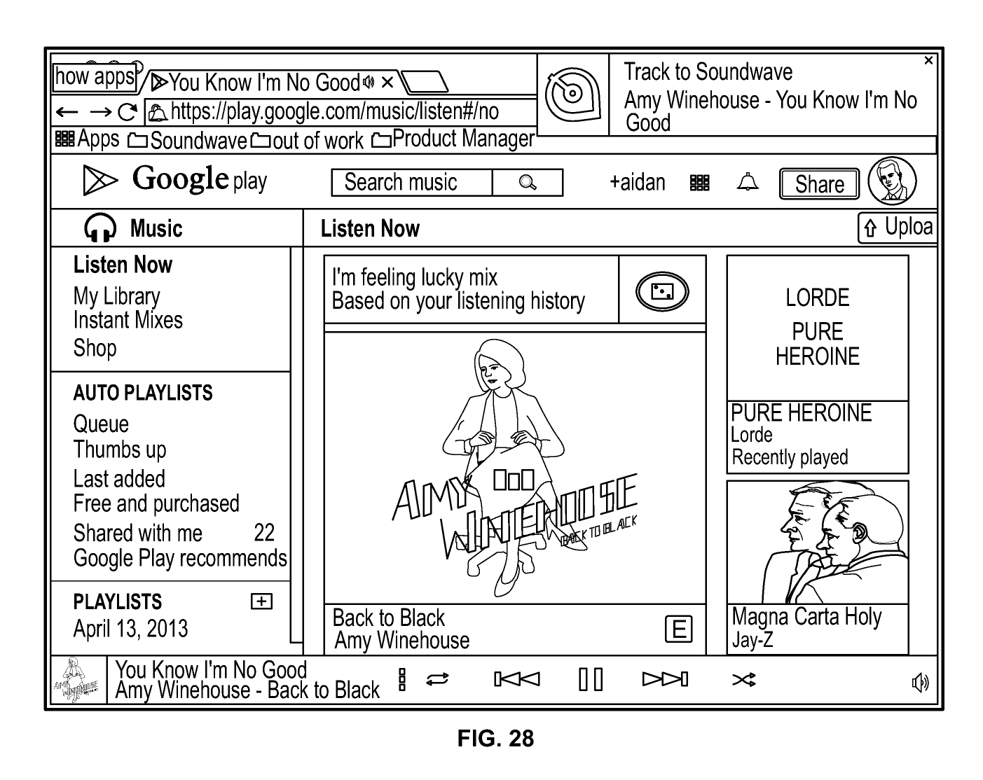

FIG. 28 is an example of how a song capture through a desktop player will look to a user of the service. In this case, the source of the desktop capture is from the Google Play Music platform.

Thus the reader will see that at least one embodiment of the present invention provides a more comprehensive and efficient approach to locating and notifying a user of the music or audio metadata matching a user's stated preference by appending location information to such metadata, and more particularly, to providing this location based information in real-time in a graphical or textual format. Furthermore, the system and method described has the additional advantages in that:
it allows for the contextualization of this metadata by tracking the timestamp and user ID associated with data when it played;
it permits the tracking of such content, together with the relevant location information across multiple platforms and from a variety of music and/or audio sources;
it allows for an efficient way to display this location information as a music map using a graphical and textual interface to visualise this information to the end user;
it allows other users on the application to listen to the music or other audio metadata through the music map (both previews and full content);
it provides a mechanism for users to share such music or other audio metadata returned within a specific area with other users within a social network or other conveyance system;
it allows for users to interact with the music or other audio metadata tracked and displayed on the music map by rating the metadata;
it provides a mechanism whereby such location-based metadata can be aggregated (by time, by user ID, by genre) to provide a real-time analysis of what music or audio is the most played in a location over a defined period and what the most recently played music or other audio metadata is in a given location.
it provides for a more efficient way to discover new music by appending location information to the playing of such music or other audio metadata.

While the above description contains many specificities, these should not be construed as limitations on the scope, but rather as an exemplification of one or several embodiments thereof. Many other variations are possible. For example, cloud lockers that store music can also be tracked using a different embodiment of our system and such platforms are likely to become more and more common as storage moves away from hardware to the cloud. Thus, a further embodiment could add cloud lockers of music as another source of metadata which can also be displayed on the music map, consumed and/or shared by the end user. Accordingly, the scope should be determined not by the embodiments illustrated, but by the appended claims and their le.g.al equivalents.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. An apparatus for locating and notifying a user of the music or audio metadata comprising:
at least one processor;
at least one memory including computer program code, the at least one memory and the computer program code configured to, with the at least one processor, cause the apparatus to perform at least the following:
track a music file or other audio metadata content in realtime on an electronic device.

2. An apparatus of claim 1, wherein the at least one processor and the at least one memory are further configured to initiate:
determination of the location or such other predetermined location-based information associated with playing of such content.

3. An apparatus of claim 1, wherein the at least one processor and the at least one memory are further configured to initiate:
receiving of first event metadata together with the contextualization of at least the user ID, timestamp or ID3 tags and the determination of a threshold information to be appended to the metadata as it is captured.

4. An apparatus of claim 3, wherein a first event data and a second event data are received and stored from a number of potential sources wherein said potential source comprises at least one of native music players, third party players, streaming services, music video services, cloud lockers and internet radio in response to a choice by a user to play such music or other audio metadata on their preferred music player.

5. An apparatus of claim 4, wherein the at least one processor and the at least one memory are further configured to track the location of where music or other audio metadata has been played if not stored locally on an electronic device.

6. An apparatus of claim 1, wherein the top rated played music or other audio metadata can be aggregated and displayed based on a user's stated predetermined preference for a specific area.

7. An apparatus of claim 1, wherein the most recently played music or other audio metadata can be aggregated and displayed based on a user's stated predetermined preference for a specific area.

8. An apparatus of claim 1, wherein the most played music or other audio metadata can be aggregated and displayed based on a user's stated predetermined preference for a specific area over a set period of time.

9. An apparatus of claim 1, wherein the most recently played music or other audio metadata can be aggregated and displayed based on a user's stated predetermined preference for a specific area over a set period of time.

10. An apparatus of claim 1, wherein the most played music or other audio metadata can be aggregated and displayed based on a user's stated predetermined preference for a specific area in respect of a certain genre of music or other audio metadata.

11. An apparatus of claim 1, wherein the most recently played music or other audio metadata can be aggregated and displayed based on a user's stated predetermined preference for a specific area in respect of a certain genre of music or other audio metadata.

12. An apparatus of claim 1, wherein any such music or audio metadata may be rated by a user in respect of the query results for a specific area.

13. An apparatus of claim 1, wherein the most liked music or other audio metadata can be aggregated and displayed based on a user's stated predetermined preference for a specific area over a set period of time and/or by specific genre of such metadata.

14. An apparatus of claim 1, wherein the most disliked music or other audio metadata can be aggregated and displayed based on a user's stated predetermined preference for a specific area over a set period of time and/or by specific genre of such metadata.

15. An apparatus of claim 1, wherein any such music or audio metadata may be shared by a user on a social network or other conveyance system in respect of the query results for a specific area.

16. An apparatus of claim 1, wherein the content comprises at least one of: audio, video, image, book or game.

17. An apparatus of claim 1, wherein the first and second event data comprises one or more of an event type, user identification, content identifier, content duration, content metadata, time stamp, and location of a user device.

18. A method of facilitating the previewing of music or other audio metadata based on a user's stated predetermined preference for a specific area over a set period of time and/or by specific genre of such metadata.

19. The method of claim 18 comprising the step of tracking of music or other audio metadata listening habits of a user in order for that user to work out their listening history based on location.

20. The method of claim 18 comprising the step of notifying and/or connecting and/or matching users, or a combination of same in different locations based on stated preferences for music or other audio metadata and/or based on the tracking of their own music or other audio metadata.

21. The method of claim 18 comprising the step of facilitating the gamification or such other commercial incentivization of music or other audio metadata listening habits in a specific location based on user IDs.

22. The method of claim 18 comprising the step of facilitating a reward system or such other commercial incentivization of music or other audio metadata listening habits in a specific location based on a user ID.

23. The method of claim 18 comprising the step of approximating the location of a user at the time a song was played using a location triangulation technique together with a timestamp of such music or other audio metadata.

24. The method of claim 18 comprising the step of providing a mechanism for a user to draw an area on a graphical interface in order to return the users stated location-based preference to define a boundary for said specific area.

25. A computer implemented method of locating and notifying a user of the music or audio metadata comprising:
tracking a music file or other audio metadata content in real-time on an electronic device.
